(19) United States
(12) Patent Application Publication
(10) Pub. No.: US 2015/0244803 A1
(43) Pub. Date: Aug. 27, 2015

(54) Block Device-Based Virtual Storage Service System and Method

(71) Applicant: HYOSUNG ITX CO., LTD, Yeongdeugpo-gu, Seoul (KR)

(72) Inventors: Tae Hoon Kim, Seoul (KR); Yong Kwang Kim, Seoul (KR)

(21) Appl. No.: 14/427,515

(22) PCT Filed: Sep. 11, 2013
(86) PCT No.: PCT/KR2013/008197

§ 371 Date: Mar. 11, 2015

(30) Foreign Application Priority Data
Sep. 11, 2012 (KR) 10-2012-0100504

(51) Int. Cl. H04L 29/08; G06F 17/30

(52) U.S. Cl. CPC H04L 67/1097; G06F 17/302

(57) ABSTRACT

Disclosed is a virtual storage service system comprising: a web server configured to receive selection information including a virtual storage capacity necessary for a virtual storage service, the number of storage nodes, storage node types, a distribution method, and a selected storage node from the terminal when the terminal requests the virtual storage service; a control center server configured to exert control with reference to the selection information so that a virtual disk volume is generated; at least one storage node configured to generate the virtual disk volume according to the control of the control center server; and a database (DB) configured to store information of the storage nodes and virtual disk volume information of the user.

### TECHNICAL FIELD

The present invention relates to a cloud computing technology, and more particularly, to a block device-based virtual storage service system and method.

### BACKGROUND ART

As cloud computing is generally raised as an issue, a distributed file system on which cloud computing is based is under active research.

Most distributed file systems are widely used due to their advantages that it is easy to share information among users and it is possible to efficiently use a storage space while reducing spatial limitations.

Such a distributed file system has characteristics as described below.

Most large-capacity file systems used in existing cloud environments are directory-based file systems.

Regardless of the types of local file systems of actual nodes, data is divided into chunks (or blocks) having a designated size in a directory designated among several distributed storage nodes and spread over all nodes in a distributed manner.

Also, the spread chunks are replicated through a pipeline two or more times among nodes.

However, since a user (or an administrator) cannot know where personal information and data spread in a distributed manner are stored, such an existing distributed file system has the risk of loss and infringement of stored information.

According to an existing method, during a disk backup of user data, data duplication cannot be avoided. In order to avoid such data duplication, it is necessary to remove data and download the data onto another disk or a server in a separate method used by a user, which is a complex and inconvenient process.

In addition, most distributed file systems perform balancing for resolving an imbalance in the amount of disk use, but it is not possible to measure the degree of imbalance at this time. Also, rebalancing is performed on all disks so that overhead may occur.

### DISCLOSURE

### Technical Problem

The present invention is directed to providing a block device-based virtual storage service system and method that propose a fundamental solution to the risk of loss and infringement of information stored in device volumes, and propose a method of performing a volume snapshot backup excluding duplicated data according to users by assigning user-specific distribution nodes to the device volumes.

The present invention is also directed to providing a block device-based virtual storage service system and method capable of measuring the degree of imbalance in the amount of disk use according to volumes allocated to users, and reducing overhead by performing rebalancing according to the allocated volumes.

### Technical Solution

One aspect of the present invention provides a block device-based virtual storage service system which is a virtual storage service system connected to at least one user terminal through a network comprising a web server configured to receive selection information including a virtual storage capacity necessary for a virtual storage service, the number of storage nodes, storage node types, a distribution method, and a selected storage node from the terminal when the terminal requests the virtual storage service; a control center server configured to exert control with reference to the selection information so that a virtual disk volume is generated; at least one storage node configured to generate the virtual disk volume according to the control of the control center server; and a database (DB) configured to store information of the storage nodes and virtual disk volume information of the user.

When the terminal requests the virtual storage service, the web server may request the terminal to input a necessary virtual storage capacity, storage node types to be generated, the number of storage nodes, and a distribution method. When the virtual storage capacity, the storage node types, the number of storage nodes, and the distribution method are input from the terminal, the web server may provide current storage node states to the terminal according to the virtual storage capacity, the storage node types, the number of storage nodes, and the distribution method. When the terminal selects the storage node to be used as a virtual storage in the node states, the web server may request the control center server to generate the virtual disk volume.

The control center server may control the selected storage node to generate the virtual disk volume by the request of the web server, and the selected storage node may generate the virtual disk volume.

Another aspect of the present invention provides a block device-based virtual storage service method which is a virtual storage service method connected to at least one terminal of a user through a network comprising: requesting, by the terminal, a virtual storage service from a web server; receiving, by the web server, selection information including a virtual storage capacity necessary for the virtual storage service, the number of storage nodes, storage node types, a distribution method, and a selected storage node from the terminal; controlling, by a control center server, the selected storage node to generate a virtual disk volume with reference to the selection information; and generating, by the selected storage node, the virtual disk volume according to the control of the control center server.

The method may further include storing, by the control center server, information of the generated virtual disk volume of the user in a DB.

The receiving of the selection information by the web server may comprise: when the terminal requests the virtual storage service, requesting the terminal to input a virtual storage capacity to be generated, storage node types, the number of storage nodes, and a distribution method; when the virtual storage capacity to be generated, the storage node types, the number of storage nodes, and the distribution method are input from the terminal, providing current storage node states to the terminal according to the virtual storage capacity to be generated, the storage node types, the number of storage nodes, and the distribution method; and when a storage node is selected in the node states by the terminal, requesting the control center server to generate the virtual disk volume.

### Advantageous Effects

Exemplary embodiments of the present invention propose a fundamental solution to the risk of loss and infringement of information stored in device volumes, and make it possible to perform a volume snapshot backup excluding duplicated data according to users by assigning user-specific distribution nodes to the device volumes.

Also, it is possible to measure the degree of imbalance in the amount of disk use according to volumes allocated to users, and reduce overhead by performing rebalancing according to the allocated volumes.

### DESCRIPTION OF DRAWINGS

FIG. 1 is a configuration diagram of a block device-based virtual storage service system according to an exemplary embodiment of the present invention.

FIG. 2 is an operational flowchart of a block device-based virtual storage service method according to an exemplary embodiment of the present invention.

FIG. 3 is a diagram illustrating user space configurations in storage nodes of a block device-based virtual storage service system according to an exemplary embodiment of the present invention.

FIG. 4 is a diagram illustrating storage of distributed files and internal storage stacks in a block device-based virtual storage service system according to an exemplary embodiment of the present invention.

### MODES OF THE INVENTION

Hereinafter, exemplary embodiments of the present invention will be described in detail with reference to the accompanying drawings so that those of ordinary skill in the art to which the present invention pertains can easily carry out the embodiments. However, exemplary embodiments of the present invention shown as examples below can be modified in various other forms, and the scope of the present invention is not limited to the exemplary embodiments described below. In order to clarify the present invention, parts which are not related with the description will be omitted from the drawings, and like reference numbers will be used to refer to like parts throughout the drawings.

When a part is referred to as “including” an element in this specification, it means that the part can further include other elements unless mentioned to the contrary. Also, terminology “ . . . portion,” “ . . . part,” “module,” etc. used herein means a unit processing at least one function or operation, and can be implemented by hardware, software, or a combination of hardware and software.

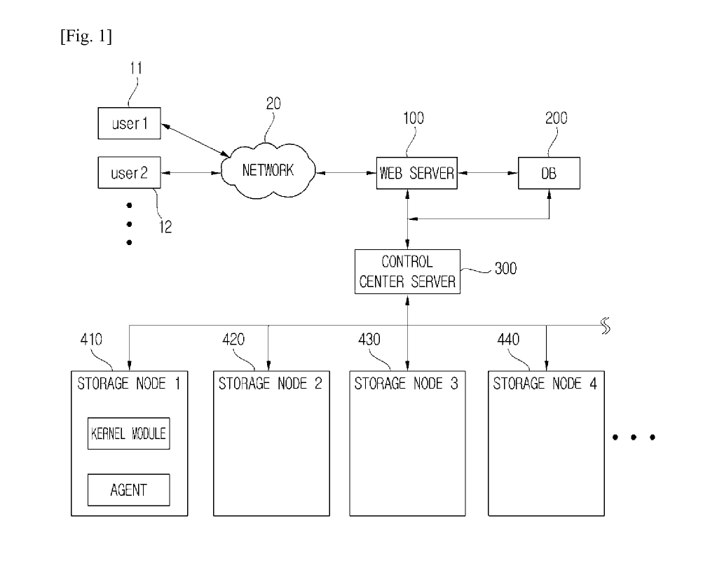

FIG. 1 is a configuration diagram of a block device-based virtual storage service system according to an exemplary embodiment of the present invention.

Referring to FIG. 1, the block device-based virtual storage service system according to an exemplary embodiment of the present invention is a virtual storage service system connected to at least one of user terminals 11 and 12 through a network 20, and the virtual storage service system comprises a web server 100, a control center server 300, storage nodes 410, 420, 430, and 440, and a database (DB) 200.

When the terminal 11 or 12 requests a virtual storage service, the web server 100 receives selection information including a virtual storage capacity necessary for the virtual storage service, the number of storage nodes, storage node types, a distribution method, and a selected storage node from the terminal 11 or 12.

The control center server 300 exerts control with reference to the selection information so that a virtual disk volume is generated.

The storage nodes 410, 420, 430 and 440 generate virtual disk volumes according to the control of the control center server 300.

The DB 200 stores information of the storage nodes 410, 420, 430 and 440 and information of the virtual disk volumes of users.

When the terminal 11 or 12 requests the virtual storage service, the web server 100 requests the terminal 11 or 12 to input a necessary virtual storage capacity, storage node types to be generated, the number of storage nodes, and a distribution method.

When the virtual storage capacity, the storage node types, the number of storage nodes, and the distribution method are input from the terminal 11 or 12, the web server 100 provides current storage node states to the terminal 11 or 12 according to the virtual storage capacity, the storage node types, the number of storage nodes, and the distribution method.

When a storage node is selected in the node states by the terminal 11 or 12, the web server 100 requests the control center server 300 to generate a selected virtual disk volume.

The control center server 300 controls the selected storage node to generate the virtual disk volume by the request of the web server, and the selected storage node generates the virtual disk volume.

Operations of the block device-based virtual storage service system having such a configuration according to an exemplary embodiment of the present invention will be described in detail below.

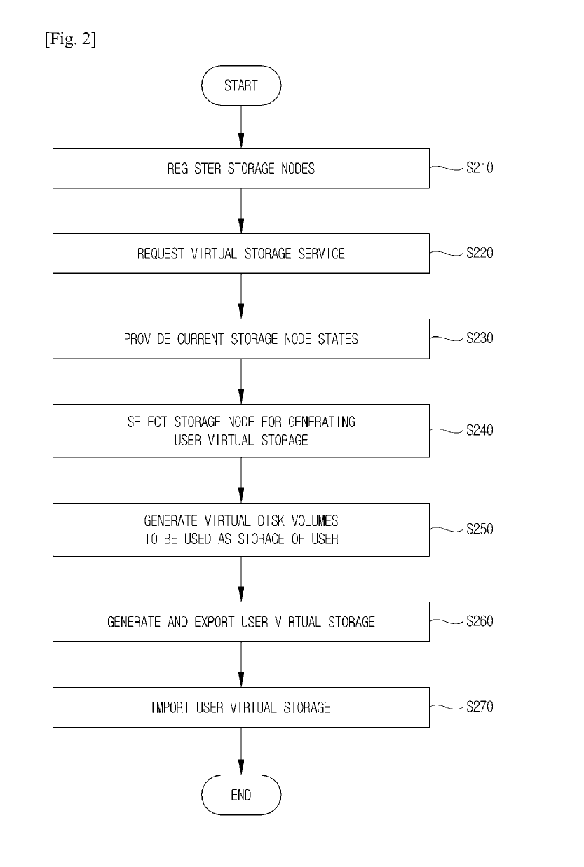

FIG. 2 is an operational flowchart of a block device-based virtual storage service method according to an exemplary embodiment of the present invention.

First, equipment (an x86-based server, etc.) of the storage nodes 410, 420, 430 and 440 to be included in a storage pool, that is, equipment in which a kernel module and an agent (software) virtualizing a storage and enabling distributed management of data are installed, is registered based on Internet protocol (IP) addresses (S210). Subsequently, the storage nodes 410, 420, 430 and 440 are managed by the control center server 300, and metadata (locations/paths of files (directories), etc.) for data management is clustered (shared in real time) at the respective storage nodes 410, 420, 430 and 440. The storage nodes 410, 420, 430 and 440 formed in this way are connected to each other through a network, so that the control center server 300 stores and manages files in a distributed manner. Here, the storage nodes 410, 420, 430 and 440 may be servers, and the number of storage nodes may increase. Also, the number of terminals 11 and 12 may increase.

This is referred to as a trusted network. A server group connected in this way is referred to as a storage pool, and each of servers is referred to as a storage node.

To virtually generate a storage to be used by a user based on a storage pool, the user first accesses the web server 100 through the network 20 using the terminal 11.

Then, the terminal 11 requests a virtual storage service from the web server 100 (S220).

When the terminal requests the virtual storage service, the web server 100 requests the terminal to input a virtual storage capacity to be generated, storage node types, the number of storage nodes, and a distribution method.

At this time, after a virtual storage capacity and storage node types are input, the number of storage nodes and a distribution method can be input in sequence. Such a sequence may vary as required.

Next, when a virtual storage capacity to be generated, storage node types, the number of storage nodes, and a distribution method are input from the terminal 11, current storage node states are transferred to the terminal 11 according to the virtual storage capacity to be generated, the storage node types, the number of storage nodes, and the distribution method (S230).

The terminal 11 selects a storage node in the current storage node states (S240), and requests the control center server 300 to generate a virtual disk volume.

Then, the control center server 300 outputs a control signal with reference to the selection information so that the selected storage node generates the virtual disk volume.

Then, according to the control of the control center server 300, the selected storage node generates the virtual disk volume (S250).

Subsequently, the generated virtual disk volume is mounted on the user terminal 11 through export and import processes (S260 and S270). In other words, the generated virtual disk volume of the storage node is imported (network mounted) into the terminal of the user and used as a local storage device.

Next, the control center server 300 stores information on the generated virtual disk volume of the user in the database.

Here, a method of generating the volume varies according to a distribution method. Storage distribution methods used in the present invention are as follows.

Distributed (D): In this method, respective files are distributed in whole to respective nodes. This method is mainly advantageous when there are a large number of small-capacity files such as document files.

Stripe (S): In this method, each file is divided into chunks of a determined size, stored, and read. This method is mainly advantageous for large-capacity files, such as video media files, when it is intended to ensure a large number of simultaneous readings.

Replication (R): In this method, each file is replicated and stored in a determined node. This method is mainly used to ensure stability of stored files and support a non-stop service.

Distributed stripe (DS): D+S: This method is mainly used to add a volume to a virtual storage that has already been present as a stripe (scale-out).

Distributed replication (DR): D+R: This method is mainly used to add a volume to a virtual storage that has already been present as a replication (scale-out).

Striped replication (SR): S+R: This method is mainly used for large-capacity files and simultaneously to ensure stability of data.

Distributed striped replication (DSR): D+S+R: This method is a combined configuration of the above methods.

In the above virtualization methods, the numbers of Ds, Ss, or Rs can be set, and according to the set numbers, it is possible to know which storage nodes have block devices to which files have been distributed, striped, or replicated.

Distribute nodes are set first, and then stripe nodes and replication nodes are set in sequence. However, in the case of a complex configuration such as DSR, the number of block devices in storage nodes are required to be the number of Ds*the number of Ss*the number of Rs, and the number of Rs is required to increase by an even number. Also, unlike a general distributed file system (in general, filenames are converted into unique values such as hash values), filenames are stored as they are, and thus it is possible to check a file using a filename and a disk usage (du) command.

For example, it is assumed that the followings are generated.

When a user virtual storage of 8 TB is generated and a distribution method is SR with 4 Ss and 2 Rs, the number of block devices for the user virtual storage in nodes is 4*2=8.

As eight storage nodes, storage nodes of 192.168.16.11 to 192.168.16.18 can be selected and used. Needless to say, other storage nodes can also be selected as eight storage nodes.

Under the above conditions, 8 TB (total capacity)/(8 (total number of block devices to be generated)/2 (number of replications))=2 TB (capacity to be generated) is generated at each of the eight storage nodes No. 11 to No. 18.

In this way, virtual disk volumes are generated.

Users virtually use virtual disk volumes generated at several storage nodes as one logical volume, and this is the concept of a virtual storage.

Since the S method is first applied to the storage nodes, stripes are applied to half the storage nodes, that is, IP Nos. 11 to 14, and the same number of replications are applied to the other storage nodes.

When virtualization is performed thereafter, it is neither possible to physically or logically know where files are distributed nor where file replication is performed in a general distributed file system.

On the other hand, according to an exemplary embodiment of the present invention, even when storage devices (block devices) of the eight different storage nodes are treated as one through virtualization, actually stored data of users is present with filenames as they are in directories in each storage node on which a block device is mounted. However, when data is stored in the Stripe method, filenames will be as they are, but the data will be divided in a chunk size and stored. In this case, the data can be checked using the du command, which is one of system calls, or so on. Also, since it is possible to know which node has a block device for replication, the backup of a block device can be performed without duplication. At this time, the backup may be performed by physical third-party equipment, or the aforementioned snapshot backup may be performed.

A snapshot and a backup of a block device are terms well known in this field, so detailed descriptions thereof will be omitted.

The virtual disk volumes generated in this way are imported (network mounted) into the terminal of the user and used as a local storage device.

This is also well known in this field so detailed description thereof will be omitted.

Internal data management of a block device-based distributed virtual storage will be described in further detail below.

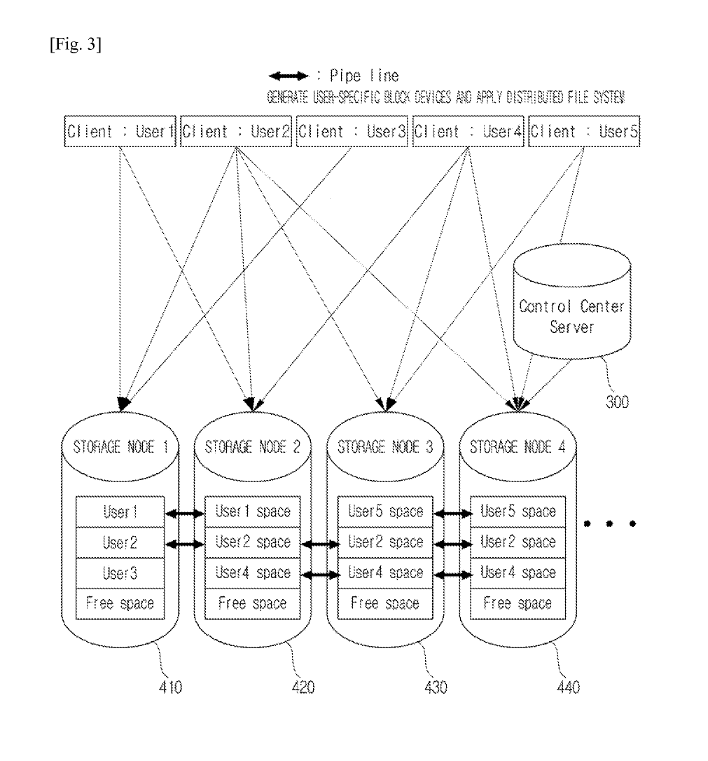

FIG. 3 shows how blocks among actual nodes are configured differently according to users.

First, in the case of user1, block device volumes are generated in storage nodes 1 and 2. Regardless of the number of storage nodes present, data is stored in or distributed to the assigned block devices only.

In the case of user2, block device volumes are distributed to all storage nodes, and only as much data as sizes of assigned volumes will be stored and distributed among all the storage nodes.

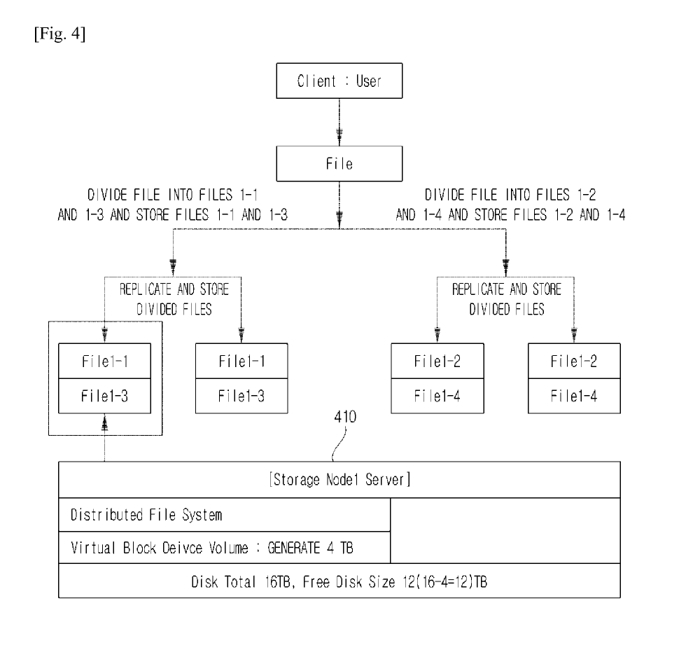

It is worthwhile to notice that respective user volumes generated in several storage nodes are different. In other words, the detailed diagram of FIG. 4 shows a data flow of one file of one user.

For description, only the most general one of several cases is simplified and shown here, but a control center server of FIG. 3 sets nodes, capacities, and distribution methods to be used by users to generate block devices, and virtualizes and provides user storages by mounting a file system and then applying the distribution methods.

Here, a user (or administrator) can know where his or her virtual storage has been assigned, and also can basically know where data is distributed and where the data is replicated and duplicated.

Data stored in the virtual disk volumes of the user is separated from a device level. Therefore, data of another user cannot physically or logically intrude the data. Also, it is possible to simply track the data, and a danger range is reduced in terms of information security.

In an exemplary embodiment of the present invention, virtual disk volumes are generated as logical block devices, and thus an access right can be set after a file system is obtained. In plain language (based on Windows operating system (OS)), in a general distributed file system, data is stored in one partition divided into only directories, and the stored data is automatically managed by a metadata server. In other words, a user cannot know a location, and from the viewpoint of a file system, data of several users in one physical partition is classified in only disk tracks but is written and read in a mixed state. Therefore, when only one account is hacked by bypassing a network port of a virtual storage for a specific user, it is possible to obtain data of all other users present in the partition (there are too many hacking algorithms based on this method, and thus only the concept has been described).

However, in an exemplary embodiment of the present invention, respective users correspond to different partitions. Therefore, even when a user uses the same disk as other users, his or her data does not overlap with data of the other users, and thus it is unnecessary to convert filenames into unique filenames such as the aforementioned hash values. In case of need, in order to prevent or track down data leakage, it is possible to strengthen security using an information protection solution, which is used in an existing method, as it is. In other words, without developing and introducing an additional method or security solution for virtualization storage, it is possible to use an information protection solution used in an existing method.

Next, volume rebalancing and a snapshot backup will be described below.

Technology for a balancing technique is a unique function in a distributed file system. Therefore, it will be only described below how effective a virtual storage combined with block devices is in a balancing operation.

Like all the above issues, it is possible to check the flow of data of volumes distributed to respective storage nodes. When data is unbalanced sometimes, that is, when distributed data of user1 is concentrated on one server, the operation of balancing block devices assigned to user1 between storage nodes 1 and 2 can be performed without affecting other volumes. In a general distributed file system, when it is intended to balance data of one user among respective nodes, balancing is performed in partition units. In other words, since data of all users coexist in one volume, the process of analyzing and balancing the data is complicated. (This involves searching metadata to match the metadata with filenames and then moving fragmented files to an appropriate location. This process causes heavy overhead. Therefore, when a node is added, rebalancing is generally performed among all nodes.) Also, it is difficult to know which user has an unbalanced data space (Needless to say, this is possible when data spaces are checked one by one by checking a system command directory capacity, but in practice, it is impossible and inefficient to check data spaces one by one by checking a system command directory capacity).

However, in an exemplary embodiment of the present invention, balancing can be performed at a block device level, so it is possible to reduce unnecessary overhead. Also, capacities of respective block devices are checked and collected by the control center server 300, and thus it is possible to know a data imbalance among nodes according to users. Therefore, in an exemplary embodiment of the present invention, it is possible to know which block data is replicated to, and a snapshot and a backup can be performed at the device level to avoid data duplication.

The above-described exemplary embodiments of the present invention are not only implemented through an apparatus and method, but can also be implemented through a program for executing functions corresponding to configurations of the exemplary embodiments of the present invention or a recording medium storing the program. Such implementation can be easily carried out by those of ordinary skill in the art to which the present invention pertains based on the descriptions of the exemplary embodiments.

While the present invention has been described with reference to certain exemplary embodiments thereof, it will be understood by those of ordinary skill in the art that various changes in form and details may be made therein without departing from the spirit and scope of the invention as defined by the appended claims.

### INDUSTRIAL APPLICABILITY

Exemplary embodiments of the present invention propose a fundamental solution to the risk of loss and infringement of information stored in device volumes, and make it possible to perform a volume snapshot backup excluding duplicated data according to users by assigning user-specific distribution nodes to the device volumes.

Also, it is possible to measure the degree of imbalance in the amount of disk use according to volumes allocated to users, and reduce overhead by performing rebalancing according to the allocated volumes.

1. A virtual storage service system connected to at least one user terminal through a network, the system comprising:
a web server configured to receive selection information including a virtual storage capacity necessary for a virtual storage service, the number of storage nodes, storage node types, a distribution method, and a selected storage node from the terminal when the terminal requests the virtual storage service;
a control center server configured to exert control with reference to the selection information so that a virtual disk volume is generated;
at least one storage node configured to generate the virtual disk volume according to the control of the control center server; and
a database (DB) configured to store information of the storage nodes and virtual disk volume information of the user.

2. The virtual storage service system of claim 1, wherein, when the terminal requests the virtual storage service, the web server requests the terminal to input a necessary virtual storage capacity, storage node types to be generated, the number of storage nodes, and a distribution method,
when the virtual storage capacity, the storage node types, the number of storage nodes, and the distribution method are input from the terminal, the web server provides current storage node states to the terminal according to the virtual storage capacity, the storage node types, the number of storage nodes, and the distribution method, and
when the terminal selects the storage node to be used as a virtual storage in the node states, the web server requests the control center server to generate the virtual disk volume.

3. The virtual storage service system of claim 1, wherein the control center server controls the selected storage node to generate the virtual disk volume by the request of the web server, and
the selected storage node generates the virtual disk volume.

4. A virtual storage service method connected to at least one user terminal through a network, the method comprising:
requesting, by the terminal, a virtual storage service from a web server;
receiving, by the web server, selection information including a virtual storage capacity necessary for the virtual storage service, the number of storage nodes, storage node types, a distribution method, and a selected storage node from the terminal;
controlling, by a control center server, the selected storage node to generate a virtual disk volume with reference to the selection information; and
generating, by the selected storage node, the virtual disk volume according to the control of the control center server.

5. The virtual storage service method of claim 4, further comprising storing, by the control center server, information of the generated virtual disk volume of the user in a database (DB).

6. The virtual storage service method of claim 5, wherein the receiving of the selection information by the web server comprises:
when the terminal requests the virtual storage service, requesting the terminal to input a virtual storage capacity to be generated, storage node types, the number of storage nodes, and a distribution method;
when the virtual storage capacity to be generated, the storage node types, the number of storage nodes, and the distribution method are input from the terminal, providing current storage node states to the terminal according to the virtual storage capacity to be generated, the storage node types, the number of storage nodes, and the distribution method; and
when a storage node is selected in the current storage node states by the terminal, requesting the control center server to generate the virtual disk volume.

7. The virtual storage service system of claim 2, wherein the control center server controls the selected storage node to generate the virtual disk volume by the request of the web server, and
the selected storage node generates the virtual disk volume.
